(19) United States
(12) Patent Application Publication
(10) Pub. No.: US 2013/0160426 A1
(43) Pub. Date: Jun. 27, 2013

(54) ROCKET ENGINE INJECTOR ASSEMBLY WITH CRYOGENIC CAVITY INSULATION

(71) Applicants: Bradley C. Johnson, Palm Beach Gardens, FL (US); John A. Harris, III, Palm Beach Gardens, FL (US); Michael J. Gehron, Stuart, FL (US)

(72) Inventors: Bradley C. Johnson, Palm Beach Gardens, FL (US); John A. Harris, III, Palm Beach Gardens, FL (US); Michael J. Gehron, Stuart, FL (US)

(21) Appl. No.: 13/336,604

(22) Filed: Dec. 23, 2011

(51) Int. Cl. F02K 9/52; B23P 15/00; B05B 15/00

(52) U.S. Cl. 60/258; 239/397.5; 29/890.01

(57) ABSTRACT

An injector assembly for a rocket engine includes a thermal insulating layer adjacent to an oxidizer cavity.

### STATEMENT REGARDING FEDERALLY SPONSORED RESEARCH OR DEVELOPMENT

This disclosure was made with Government support under NNM05AB08C awarded by NASA. The Government has certain rights in this disclosure.

### BACKGROUND

The present invention relates to a rocket engine, and more particularly to an injector assembly therefor.

One type of deep-throttling rocket engine is the Common Extensible Cryogenic Engine (CECE). The CECE may be utilized as a descent engine for Lunar Surface Access. Deep-throttling rocket engines may be relatively sensitive to instabilities when throttled to very low power levels as the propellants may drop below their critical temperatures.

### SUMMARY

An injector assembly for a rocket engine according to an exemplary aspect of the present disclosure includes a thermal insulating layer adjacent to an oxidizer cavity.

A rocket engine according to an exemplary aspect of the present disclosure includes an inter-propellant plate between a cover plate and a transpiration cooled face plate. An oxidizer cavity defined between the cover plate and the inter-propellant plate. A fuel cavity between the transpiration cooled face plate and the inter-propellant plate. A thermal insulating layer on the inter-propellant plate adjacent to the oxidizer cavity.

A method of manufacturing an injector assembly of a rocket engine according to an exemplary aspect of the present disclosure includes layering a Perfluoroalkoxy (PFA) onto an inter-propellant plate on a side adjacent to an oxidizer cavity.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a general schematic sectional view of an exemplary rocket engine;

FIG. 2 is an expanded schematic view of an injector assembly;

FIG. 3 is an expanded schematic view of an inter-propellant plate assembly of the injector assembly;

FIG. 4 is an schematic sectional view of the inter-propellant plate assembly; and

FIG. 5 is an expanded schematic sectional view of the inter-propellant plate assembly.

### DETAILED DESCRIPTION

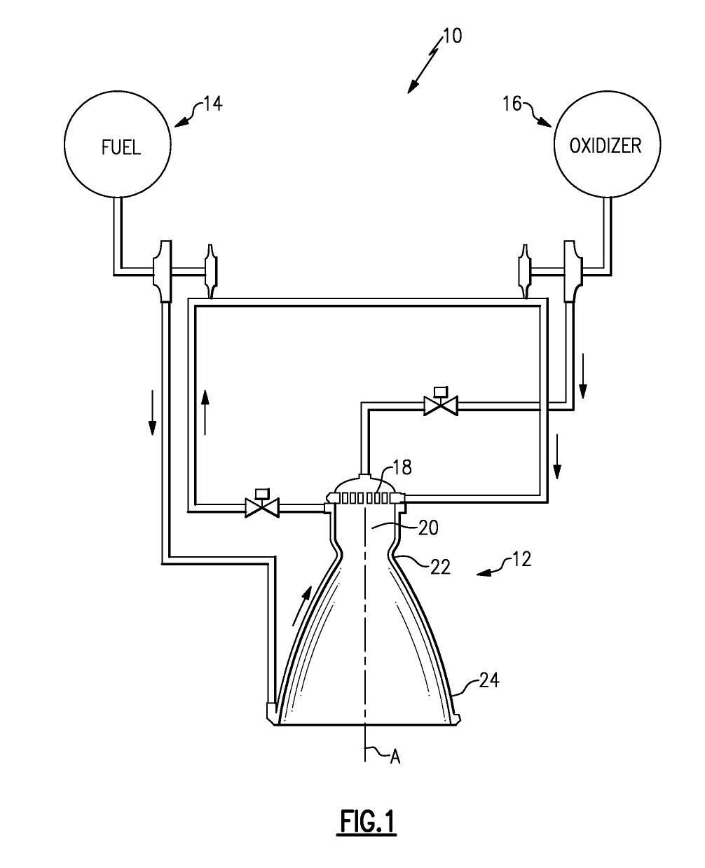

FIG. 1 illustrates a general schematic view of a deep throttling rocket engine 10 such as high performance Common Extensible Cryogenic Engine (CECE). The engine 10 generally includes a nozzle 12 in communication with a propellant system having a fuel system 14 and an oxidizer system 16. While applicable to various rocket engines that utilize various fluid propellants, the engine disclosed herein utilizes gaseous hydrogen as the fuel and liquid oxygen as the oxidizer.

The fuel system 14 and the oxidizer system 16 provide the fuel and the oxidizer into the nozzle 12 through an injector assembly 18. The nozzle 12 generally includes a combustion chamber 20, a throat 22 and a skirt 24 which define a thrust axis A. Combustion gases downstream of the injector assembly 18 flow through the nozzle 12 in the axial direction, passing first through the combustion chamber 20, then through the throat 22, and finally through the skirt 24 to provide thrust.

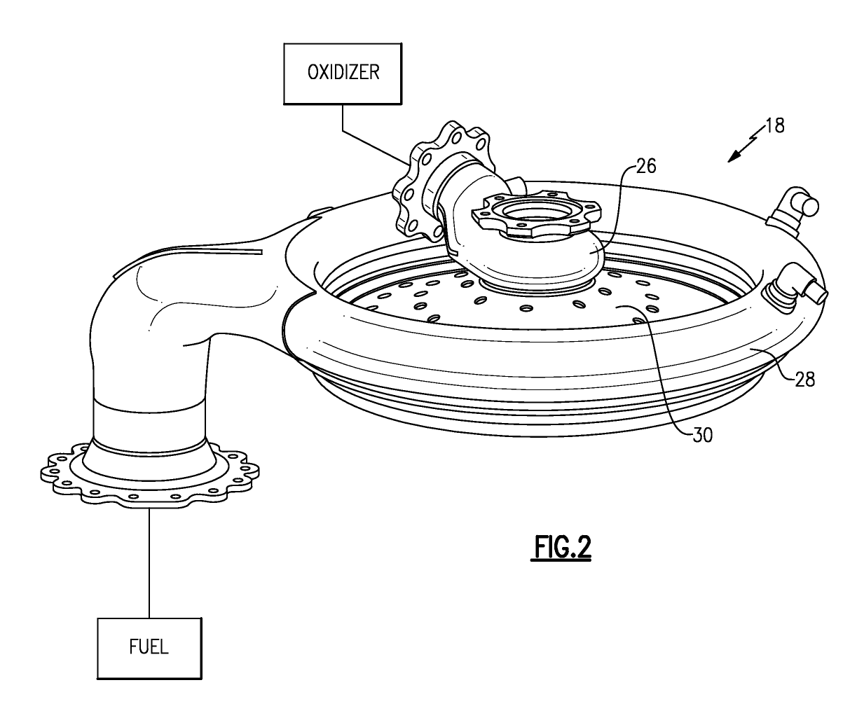

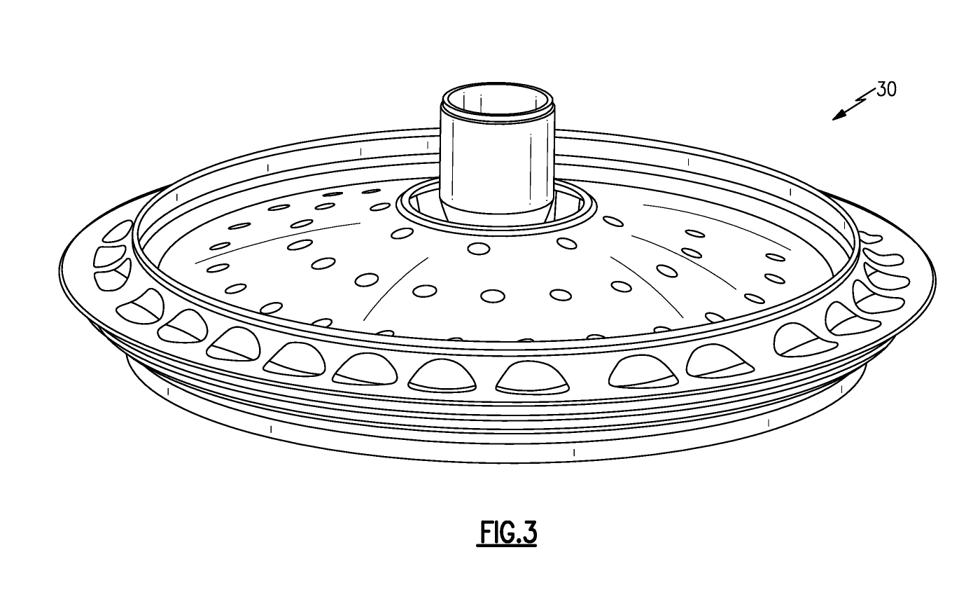

With reference to FIG. 2, the injector assembly 18 generally includes an oxidizer manifold 26 and a fuel manifold 28 in communication with an inter-propellant plate assembly 30 (also shown in FIG. 3). The oxidizer manifold 26 may be at least partially defined along the thrust axis A and the fuel manifold 28 may be at least partially defined there around in an annular relationship.

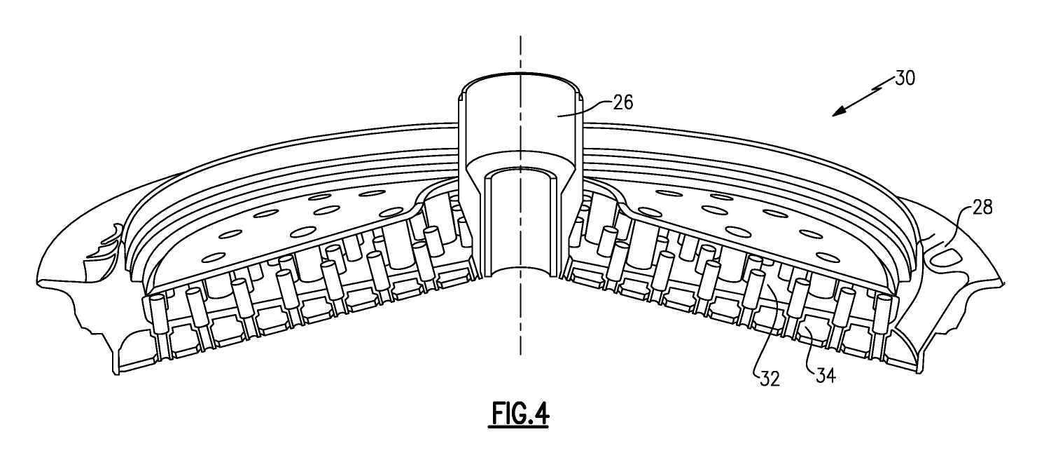

With reference to FIG. 4, the oxidizer manifold 26 communicates oxidizer therefrom into an oxidizer cavity 32 and the fuel manifold 28 communicates fuel into a fuel cavity 34 of the inter-propellant plate assembly 30. It should be appreciated that various cavity configurations and plate architectures are contemplated herein and readily applicable to the disclosed teachings.

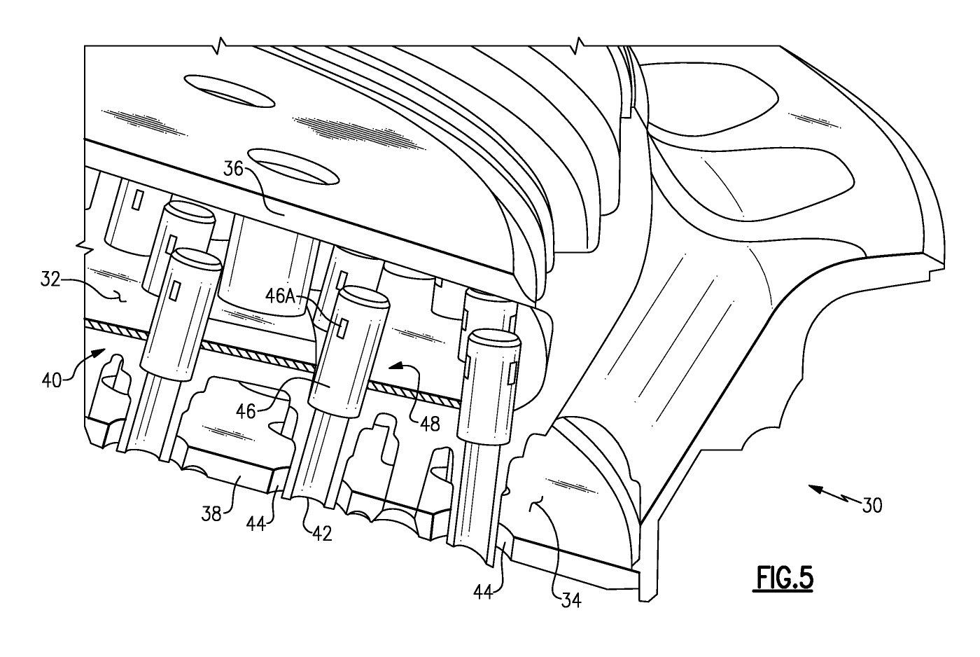

With reference to FIG. 5, the inter-propellant plate assembly 30 generally includes a cover plate 36, a transpiration cooled face plate 38 and an inter-propellant plate 40 therebetween. The oxidizer cavity 32 is located between the cover plate 36 and the inter-propellant plate 40 and the fuel cavity 34 is defined between the transpiration cooled face plate 38 and the inter-propellant plate 40.

The oxidizer cavity 32 communicates with the combustion chamber 20 (FIG. 1) through a plurality of oxidizer injector passages 42. The fuel cavity 34 communicates with the combustion chamber 20 (FIG. 1) through a plurality of fuel injector passages 44.

Each of the plurality of oxidizer injector passages 42 may include a swirl cap 46 which provides a metering orifice 46A for the oxidizer. The plurality of oxidizer injector passages 42 are arranged about the thrust axis A and each of the plurality of fuel injector passages 44 are arranged generally around an associated oxidizer injector passages 42.

The inter-propellant plate 40 includes a thermal insulating layer 48 applied to a side thereof adjacent to the oxidizer cavity 32. The thermal insulating layer 48 facilitates a reduction in the heat transfer from the relatively warm fuel cavity 34 to the relatively cold oxidizer cavity 32 side of the injector assembly 18. Reduction in heat transfer thereacross facilitates the reduction or elimination of a combustion instability source during low power throttling often referred to as “chugging.” The application of the thermal insulating layer 48 permits reduced heat transfer and permits deep throttling operation when the cryogenic LOX pressure may be reduced below the critical point, without resulting in combustion instability.

In one disclosed, non-limiting embodiment, the thermal insulating layer 48 is Perfluoroalkoxy (PFA) which is a member of the Fluorocarbon family of materials which offer both low thermal conductivity and chemically inert behavior. The Perfluoroalkoxy (PFA) may be layered in the disclosed, non-limiting embodiment, to a depth of up to 0.050 inches (1.27 mm) maximum, as required, to provide a desired reduction in heat transfer. PFA has the relatively unique ability to be applied in a layered approach, which permits the desired insulation thickness to be achieved in a homogeneous, well-structured layer.

With the best mode for carrying out the invention and the operation thereof having been described, certain additional features and benefits can now be more readily appreciated. The thermal insulating layer 48 provides, for example: sufficient thermal resistance to reduce or eliminate LOX-induced chugging with a thickness acceptable to geometric constraints of the injector assembly 18; demonstrates LOX and chemical/metallurgical processing compatibility; adheres effectively under all injector assembly processing; and functions properly without damage under operating conditions.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present invention.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the invention may be practiced other than as specifically described. For that reason the appended claims should be studied to determine true scope and content.

What is claimed:

1. An injector assembly for a rocket engine comprising:
a thermal insulating layer adjacent to an oxidizer cavity.

2. The assembly as recited in claim 1, wherein said thermal insulating layer is a member of the Fluorocarbon family of materials.

3. The assembly as recited in claim 1, wherein said thermal insulating layer is Perfluoroalkoxy (PFA).

4. The assembly as recited in claim 1, wherein said thermal insulating layer is applied to an inter-propellant plate.

5. The assembly as recited in claim 4, wherein said inter-propellant plate is between a cover plate and a transpiration cooled face plate, said oxidizer cavity located between said cover plate and said inter-propellant plate.

6. The assembly as recited in claim 5, further comprising a fuel cavity defined between said transpiration cooled face plate and said inter-propellant plate.

7. A rocket engine comprising:
a cover plate;
a transpiration cooled face plate;
an inter-propellant plate between said cover plate and said transpiration cooled face plate;
an oxidizer cavity between said cover plate and said inter-propellant plate;
a fuel cavity between said transpiration cooled face plate and said inter-propellant plate; and
a thermal insulating layer on said inter-propellant plate adjacent to the oxidizer cavity.

8. The rocket engine as recited in claim 7, wherein said thermal insulating layer is a member of the Fluorocarbon family of materials.

9. The rocket engine as recited in claim 7, wherein said thermal insulating layer is Perfluoroalkoxy (PFA).

10. The rocket engine as recited in claim 7, wherein said transpiration cooled face plate is adjacent to a combustion chamber.

11. The rocket engine as recited in claim 7, wherein said cover plate, said transpiration cooled face plate and said inter-propellant plate forms an inter-propellant plate subassembly of an injector assembly.

12. A method of manufacturing an injector assembly of a rocket engine comprising:
layering a Perfluoroalkoxy (PFA) onto an inter-propellant plate adjacent on a side adjacent to an oxidizer cavity.

13. The method as recited in claim 12, wherein the layering forms a depth of up to 0.050 inches (1.27 mm) maximum, as required.
